(19) United States
(12) Patent Application Publication
(10) Pub. No.: US 2026/0213905 A1
(43) Pub. Date: Jul. 23, 2026

(54) A METHOD AND APPARATUS FOR PERFORMING PUSCH DMRS BUNDLING IN WIRELESS COMMUNICATION SYSTEM

(71) Applicant: Innovative Technology Lab Co., Ltd., Seoul (KR)

(72) Inventor: Dong Hyun Park, Seoul (KR)

(21) Appl. No.: 19/141,925

(22) PCT Filed: Dec. 20, 2023
(86) PCT No.: PCT/KR2023/021113

§ 371 Date: Jun. 20, 2025

(30) Foreign Application Priority Data
Dec. 20, 2022 (KR) 10-2022-0179701

(51) Int. Cl. H04L 5/00

(52) U.S. Cl. CPC H04L 5/0051

(57) ABSTRACT

Provided is a wireless user device that is connected to a satellite on the basis of an NTN in a wireless communication system, wherein NTN DMRS bundling-related setting information and DMRS bundling enabling instruction information may be acquired via upper later signaling pre-compensation procedure application time information may be transmitted to a base station on the basis of the upper layer signaling and PUSCH with DMRS may be transmitted to the base station via DMRS bundling on the basis of the pre-compensation procedure application time information.

### TECHNICAL FIELD

The present invention relates to a method and apparatus for performing PUSCH (physical uplink shared channel) DMRS (demodulation reference signal) bundling in a wireless communication system. The present invention relates to a method and apparatus for performing PUSCH DMRS bundling based on non-terrestrial networks (NTN).

### RELATED ART

The International Telecommunication Union (ITU) develops the International Mobile Telecommunication (IMT) framework and standards, and recently, it is ongoing a discussion for 5th generation (5G) communication through a program called “IMT for 2020 and beyond”.

To satisfy the requirements requested by “IMT for 2020 and beyond,” the 3rd Generation Partnership Project (3GPP) new radio (NR) system is being discussed to support various numerologies about a time-frequency resource unit standard by considering various scenarios, service requirements, and potential system compatibility.

Also, 5G communication may support transmission of a physical signal or physical channel through a plurality of beams to overcome a poor channel environment, such as high pathloss, phase-noise, and frequency offset, that occurs on a high carrier frequency. Through this, 5G communication may support applications, such as enhanced Mobile Broadband (eMBB), massive Machine Type Communications (mMTC), and Ultra Reliable and Low Latency Communication (URLLC).

Also, Vehicle-to-everything (V2X) communication, a communication method of exchanging or sharing road infrastructures during driving and information, such as traffic conditions, through communication with other vehicles, may be considered. V2X may include, for example, vehicle-to-vehicle (V2V), which may refer to a long term evolution (LTE)-based/New Radio (NR) based communication between vehicles, vehicle-to-pedestrian (V2P), which may refer to LTE-based/NR-based communication between a vehicle and a user equipment (UE) carried by a user, and a vehicle-to-infrastructure/network (V2I/N), which may refer to a LTE-based/NR-based communication between a vehicle and a roadside unit (RSU)/network. The RSU may be a transportation infrastructure entity configured by a base station or a fixed UE, such as, an entity that transmits a speed notification to a vehicle.

### DETAILED DESCRIPTION

### Technical Subject

The present invention relates to a method and apparatus for performing PUSCH DMRS bundling in a wireless communication system.

The present invention relates to a method and apparatus for performing PUSCH DMRS bundling in an NTN environment.

The present invention relates to a method and apparatus for obtaining higher layer signaling related to DMRS bundling for PUSCH DMRS bundling in an NTN environment.

The present invention relates to a method and apparatus for performing a pre-compensation procedure in consideration of PUSCH DMRS bundling in an NTN environment.

Technical subjects achievable from the present disclosure are not limited to the aforementioned technical subjects and still other technical subjects not described herein may be clearly understood by one of ordinary skill in the art to which the disclosure pertains from the following description.

### Technical Solution

According to an embodiment, a wireless user device connected to a satellite based on non-terrestrial networks (NTN) in a wireless communication system includes at least one antenna for transmitting and receiving one or more wireless signals, at least one processor, and a memory storing instructions for the wireless user device to be executed by the at least one processor, wherein an operation of the wireless user device includes: obtaining NTN demodulation reference signal (DMRS) bundling related configuration information and DMRS bundling enable indication information through higher layer signaling; transmitting, based on the higher layer signaling, pre-compensation procedure application time information to a base station; and transmitting a physical uplink shared channel (PUSCH) to the base station with a DMRS through DMRS bundling based on the pre-compensation procedure application time information.

Also, according to an embodiment, the pre-compensation procedure may include at least one of a TA update, a validity duration update, and an epoch time reception/update.

Also, according to an embodiment, the base station determines a nominal time domain window (NTDW) and an actual time domain window (ATDW) based on the pre-compensation procedure application time information received from the wireless user device, and may decode the PUSCH based on the DRMS bundling within the determined ATDW.

Also, according to an embodiment, when DMRS bundling is applied, the wireless user device may transmit at least one of DMRS and coherent DMRS in a plurality of slots.

Also, according to an embodiment, a wireless user device that performs conditional handover based on non-terrestrial networks (NTN) in a wireless communication system, the wireless user device including: at least one antenna that transmits and receives one or more wireless signals, at least one processor, and a memory that stores instructions for the wireless user device, wherein the operation of the wireless user device includes: obtaining NTN demodulation reference signal (DMRS) bundling related configuration information and DMRS bundling enable indication information through higher layer signaling, performing a pre-compensation procedure based on a pre-compensation procedure application time set by a base station, and transmitting a physical uplink shared channel (PUSCH) to the base station along with a DMRS through DMRS bundling at a time other than the pre-compensation procedure performance time.

Also, according to an embodiment, a timing of applying the pre-compensation procedure may be included in the higher layer signaling.

Also, according to an embodiment, the pre-compensation procedure may include at least one of a TA update, a validity duration update, and an epoch time reception/update.

Also, according to an embodiment, when DMRS bundling is applied, the wireless user device may transmit at least one of DMRS and coherent DMRS in a plurality of slots.

The features briefly summarized above with respect to the present disclosure are only exemplary aspects of the detailed description of the present disclosure to be described later, and do not limit the scope of the present disclosure.

### Effect

According to the present disclosure, it is possible to provide a method of performing PUSCH DMRS bundling in a wireless communication system.

According to the present disclosure, it is possible to provide a method for performing PUSCH DMRS bundling in an NTN environment.

According to the present disclosure, it is possible to provide a method for obtaining higher layer signaling related to DMRS bundling for PUSCH DMRS bundling in an NTN environment.

According to the present disclosure, it is possible to provide a method of performing a pre-compensation procedure in consideration of PUSCH DMRS bundling in an NTN environment.

The present disclosure is not limited to the above-described effects, and other effects not mentioned may be clearly understood by one of ordinary skill in the art to which the present disclosure pertains from the following description.

### BRIEF DESCRIPTION OF DRAWINGS

FIG. 1 illustrates an NR frame structure to which the present disclosure may be applied.

FIG. 2 illustrates an NR resource structure to which the present disclosure may apply.

FIG. 3 illustrates a non-terrestrial network (NTN) including a transparent satellite to which the present disclosure may be applied.

FIG. 4 illustrates a NTN including regenerative satellites without Inter-Satellite Links (ISL) to which the present disclosure may apply.

FIG. 5 illustrates an NTN including regenerative satellites with ISL to which the present disclosure may be applied.

FIG. 6 illustrates a user plane (UP) protocol stack structure in an NTN including a transparent satellite to which the present disclosure may be applied.

FIG. 7 illustrates a control plane (CP) protocol stack structure in a non-terrestrial network (NTN) including a transparent satellite to which the present disclosure may apply.

FIG. 8 illustrates a timing advance calculation method to which the present disclosure may apply.

FIG. 9 illustrates a fixed cell scenario (earth fixed cell scenario) to which the present disclosure may apply.

FIG. 10 illustrates a earth moving cell scenario to which the present disclosure may apply.

FIG. 11 illustrates a method of mapping a physical cell identity (PCI) to satellite beams to which the present disclosure may apply.

FIG. 12 illustrates a reference location to which the present disclosure may apply.

FIG. 13 illustrates an NTN structure providing a relay function that can be applied to the present disclosure.

FIG. 14 illustrates an NTN structure providing a multi-connectivity function applicable to the present disclosure.

FIG. 15 illustrates a method of configuring TA in an NTN environment applicable to the present disclosure.

FIG. 16 illustrates a method of applying PUSCH DMRS bundling based on a pre-compensation update report applicable to the present disclosure.

FIG. 17 illustrates a method of applying PUSCH DMRS bundling based on an advanced compensation update report applicable to the present disclosure.

FIG. 18 illustrates a method of applying PUSCH DMRS bundling in consideration of an ATDW boundary applicable to the present disclosure.

FIG. 19 is a flowchart illustrating a method of applying DMRS bundling in an NTN environment to which the present disclosure is applicable.

FIG. 20 is a flowchart illustrating a method of applying DMRS bundling in an NTN environment to which the present disclosure is applicable.

FIG. 21 is a diagram illustrating a device configuration applicable to the present disclosure.

### BEST MODE

Hereinafter, examples of the present disclosure will be described in detail with reference to the accompanying drawings such that one of ordinary skill in the art to which the present disclosure pertains may easily implement the examples. However, the present disclosure may be implemented in various different forms and is not limited to the examples described herein.

In describing the embodiments of the present disclosure, if a detailed description of a known configuration or function is considered to obscure the subject matter of the present disclosure, a detailed description thereof will be omitted. Also, in the drawings, parts not related to the description of the present disclosure are omitted, and like reference numerals are used for similar parts.

It will be understood that when an element is referred to as being “connected to,” “coupled to,” or “accessed to” another element, it can be directly connected, coupled, or accessed to the other element or intervening elements may be present. Also, it will be further understood that when an element is described to “comprise/include” or “have” another element, it specifies the presence of another element, but does not preclude the presence of another element unless otherwise described.

In the present disclosure, terms such as first, second, and the like, are used only for the purpose of distinguishing one element from another, and do not limit the order or importance of the elements, unless specifically mentioned. Therefore, within the scope of the present disclosure, a first element in one embodiment may be referred to as a second element in another embodiment, and similarly, a second element in one embodiment may be referred to as a first element in another embodiment.

Herein, distinguishing elements are merely provided to clearly explain the respective features and do not represent that the elements are necessarily separate from each other. That is, a plurality of elements may be integrated into a single hardware or software unit. Also, a single element may be distributed to a plurality of hardware or software units. Therefore, unless particularly described, the integrated or distributed example is also included in the scope of the disclosure.

Herein, elements described in various examples do not necessarily mean essential elements, and some may be optional elements. Therefore, an example including a partial set of elements described in an example is also included in the scope of the disclosure. Also, an example that additionally includes another element to elements described in various examples is also included in the scope of the disclosure.

The description described herein is related to a wireless communication network, and an operation performed in the wireless communication network may be performed in a process of controlling a network and transmitting or receiving a signal in a system that controls the wireless communication network (e.g., a base station), or may be performed in a process of transmitting or receiving a signal in a terminal connected to the wireless network.

It is apparent that various operations performed for communication with a terminal in a network including a base station and a plurality of network nodes may be performed by the base station or by other network nodes in addition to the base station. Here, the term ‘base station (BS)’ may be interchangeably used with other terms, for example, a fixed station, a Node B, eNodeB (eNB), ng-eNB, gNodeB (gNB), and an access point (AP). Also, the term ‘terminal’ may be interchangeably used with other terms, for example, user equipment (UE), a mobile station (MS), a mobile subscriber station (MSS), a subscriber station (SS), and a non-AP station (non-AP STA).

Herein, transmitting or receiving a channel includes a meaning of transmitting or receiving information or a signal through the corresponding channel. For example, transmitting a control channel indicates transmitting control information or a signal through the control channel. Likewise, transmitting a data channel indicates transmitting data information or a signal through the data channel.

In the following description, although the term “new radio (NR) system” is used to distinguish a system according to various examples of the present disclosure from the existing system, the scope of the present disclosure is not limited thereto.

In the NR system, various subcarrier spacings (SCSs) are supported in consideration of various scenarios, service requirements, potential system compatibility, and the like. Also, the NR system may support transmission of a physical signal/channel through a plurality of beams to overcome a poor channel environment, such as high path-loss, phase-noise, and frequency offset, that occurs on a high carrier frequency. Through this, the NR system may support applications, such as enhanced Mobile Broadband (eMBB), massive Machine Type Communications (mMTC)/ultra Machine Type Communications (uMTC), and Ultra Reliable and Low Latency Communications (URLLC).

Here, the 5G mobile communication technology may be defined by including not only the NR system but also the existing Long Term Evolution-Advanced (LTE-A) system and Long Term Evolution (LTE) system. The 5G mobile communication technology may include a technology that operates by considering backward compatibility with a previous system as well as a newly defined NR system. Therefore, the following 5G mobile communication may include a technology operating based on the NR system and a technology operating based on a previous system (e.g., LTE-A, LTE), but is not limited to a specific system.

First, the physical resource structure of the NR system to which the present invention is applied will be briefly described.

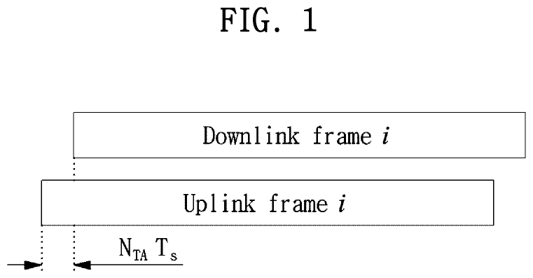

FIG. 1 illustrates an NR frame structure to which the present disclosure may be applied.

In NR, a basic unit of a time domain may be T_{c}=1/(Δfₘₐₓ·N_{f}) where Δfₘₐₓ=480·10³ and N_{f}=4096. In LTE, a basic unit of a time domain may be Tₛ=1/(Δf_{ref}·N_{f,ref}) where Δf_{ref}=15·10³ and N_{f,ref}=2048. A constant for a multiple relationship between the NR time basic unit and the LTE time basic unit may be defined as k=Tₛ/T_{c}=64.

Referring to FIG. 1, a time structure of a frame for downlink/uplink (DL/UL) transmission may have T_{f}=(Δfₘₐₓ·N_{f}/100)·Tₛ=10 ms. Here, one frame consists of 10 subframes corresponding to T_{sf}=(Δfₘₐₓ·N_{f}/1000)·Tₛ=1 ms. The number of consecutive OFDM symbols in a subframe may be

$${N}_{symb}^{subframe , μ} = {N}_{symb}^{slot} \cdot {N}_{slot}^{subframe , μ} .$$

In addition, each frame is divided into two half-frames of the same size, and half-frame 1 consists of subframes 0-4, and half-frame 2 consists of subframes 5-9.

The N_{TA} represents the timing advance (TA) between downlink (DL) and uplink (UL). Here, a transmission timing of the uplink transmission frame i is determined based on a downlink reception timing at a UE according to the following Equation 1.

$${T}_{TA} = ( {N}_{TA} + {N}_{TA , offset} ) {T}_{c} \qquad [ Equation 1 ]$$

Here, N_{TA,offset} denotes a TA offset value occurring due to a duplex mode difference and the like. In a frequency division duplex (FDD), N_{TA,offset} is 0. In a time division duplex (TDD), N_{TA,offset} may be defined as a fixed value by considering a margin for a DL-UL switching time. For example, in the TDD (Time Division Duplex) of FR1 (Frequency Range 1) which is a sub-6 GHz frequency, N_{TA,offset} may be 39936 or 25600. 39936 is 20.327 μs and 25600 is 13.030 μs. Also, in FR2 (Frequency Range 2) which is a millimeter wave (mmWave) frequency, N_{TA,offset} may be 13792. At this time, 39936 is 7.020 μs.

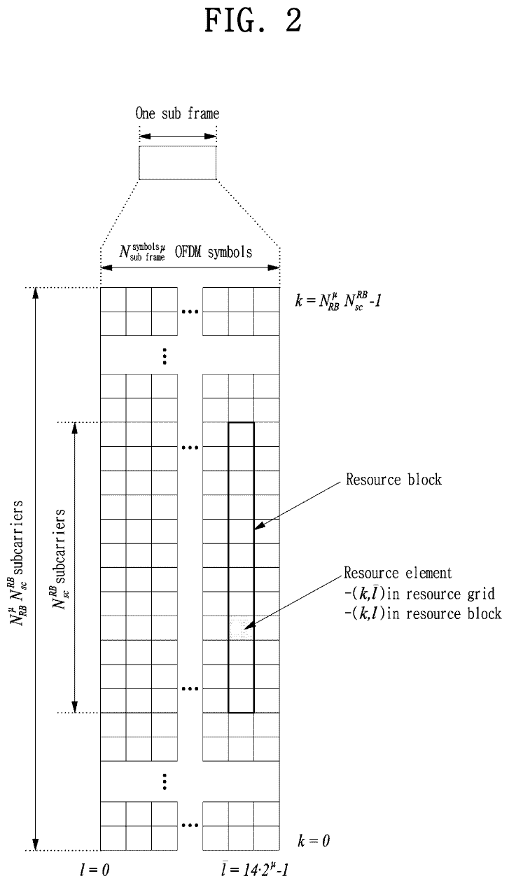

FIG. 2 illustrates an NR resource structure to which the present disclosure may apply.

A resource element within a resource grid may be indexed based on each subcarrier spacing. Here, a single resource grid may be generated for each antenna port and for subcarrier spacing. Uplink/downlink transmission and reception may be performed based on a corresponding resource grid.

A resource block (RB) on a frequency domain is configured of 12 REs and for every 12 REs, an index for one RB (nPRB) may be configured. The index for RB may be utilized within a specific frequency band or system bandwidth. The index for RB may be defined as shown in Equation 2 below. Here,

$${N}_{sc}^{RB}$$

represents the number of subcarriers per one RB and k represents the subcarrier index.

$${n}_{PRB} = ⌊ \frac{k}{{N}_{sc}^{RB}} ⌋ \qquad [ Equation 2 ]$$

Numerologies may be variously configured to meet the various services and requirements of the NR system. For example, one subcarrier spacing (SCS) may be supported in the LTE/LTE-A system, but a plurality of SCS may also be supported in the NR system.

A new numerology for the NR system that supports the plurality of SCSs may operate in a frequency range or carrier, such as 3 GHz or less, 3 GHZ-6 GHz, 6 GHZ-52.6 GHZ, or 52.6 GHz or more, to solve the issue that a wide bandwidth is unavailable in a frequency range or carrier such as 700 MHz or 2 GHz.

Table 1 below shows an example of numerology supported in the NR system.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Referring to the above Table 1, the numerologies may be defined based on a subcarrier spacing (SCS), a cyclic prefix (CP) length, and a number of OFDM symbols per slot, which are used in an OFDM system. The aforementioned values may be provided to a UE through the higher layer parameters, DL-BWP-mu and DL-BWP-cp, for the downlink, and through the higher layer parameters, UL-BWP-mu and UL-BWP-cp, for the uplink.

In the above Table 1, if the subcarrier spacing configuration index (u) is 2, the subcarrier spacing (Δf) is 60 kHz, and a normal CP and an extended CP may be applied. For other numerology indices, only the normal CP may be applied.

A normal slot may be defined as a basic time unit used to transmit a single piece of data and control information in the NR system. A length of the normal slot may basically include 14 OFDM symbols. Also, dissimilar to a slot, a subframe may have an absolute time length corresponding to 1 ms in the NR system and may be used as a reference time for the length of another time section. Here, for the coexistence and backward compatibility of the LTE and the NR system, a time section, such as an LTE subframe, may be required for an NR standard.

For example, in LTE, data may be transmitted based on a transmission time interval (TTI) that is a unit time, and the TTI may be set in units of one or more subframes. Here, one subframe may be set to 1 ms and may include 14 OFDM symbols (or 12 OFDM symbols).

Also, in the NR system, a non-slot may be defined. The non-slot may refer to a slot having a number of symbols less by at least one symbol than that of the normal slot. For example, in the case of providing a low latency such as a Ultra-Reliable and Low Latency Communications (URLLC) service, a latency may decrease through the non-slot having the number of slots less than that of the normal slot. Here, the number of OFDM symbols included in the non-slot may be determined based on a frequency range. For example, a non-slot with 1 OFDM symbol length may be considered in the frequency range of 6 GHZ or more. As another example, the number of symbols used to define the non-slot may include at least two OFDM symbols. Here, the range of the number of OFDM symbols included in the non-slot may be configured with a length of a mini slot up to (normal slot length)−1. Here, although the number of OFDM symbols may be limited to 2, 4, or 7 as a non-slot standard, it is provided as an example only.

In addition, for example, in the unlicensed bands below 6 GHZ, subcarrier spacing with μ=1 and μ=2 may be used, and in the unlicensed bands above 6 GHz, subcarrier spacing with μ=3 and μ=4 may be used. For example, μ=4 may be used for a Synchronization Signal Block (SSB).

TABLE 2

| μ | ${N}_{s y m b}^{slot}$ | ${N}_{slot}^{frame , u}$ | ${N}_{slot}^{subframe , u}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows, for each subcarrier spacing configuration (u), the number of OFDM symbols per slot for a normal CP

$$( {N}_{symb}^{slot} ) ,$$

the number of slots per frame

$$( {N}_{slot}^{frame , u} ) ,$$

and the number of slots per subframe

$$( {N}_{slot}^{subframe , u} ) .$$

Table 2 snows the above-mentioned values based on a normal slot having 14 OFDM symbols.

TABLE 3

| μ | ${N}_{s y m b}^{slot}$ | ${N}_{slot}^{frame , u}$ | ${N}_{slot}^{subframe , u}$ |
|---|---|---|---|
| 2 | 12 | 40 | 4 |

In Table 3, in the case of the extended CP applied (that is, μ=2 and SCS=60 kHz), the number of slots per frame and the number of slots per subframe are shown based on a normal slot in which the number of OFDM symbols per slot is 12.

As described above, a single subframe may correspond to 1 ms on a time axis. Also, a single slot may correspond to 14 symbols on the time axis. For example, a single slot may correspond to 7 symbols on the time axis. Therefore, the number of slots and the number of symbols that may be considered may be differently set within 10 ms corresponding to a single radio frame. Table 4 may show the number of slots and the number of symbols according to each SCS. Although the SCS of 480 kHz may not be considered in Table 4, the present disclosure is not limited to such examples.

TABLE 4

| | | Number of slots | Number of slots | Number of |
|---|---|---|---|---|
| | | within 10 ms (14 | within 10 ms (7 | symbols |
| SCS | | symbols per slot) | symbols per slot) | within 10 ms |
| 15 | kHz | 10 | 20 | 140 |
| 30 | kHz | 20 | 40 | 280 |
| 60 | kHz | 40 | 80 | 560 |
| 120 | kHz | 80 | N/A | 1120 |
| 240 | kHz | 160 | N/A | 2240 |
| 480 | kHz | 320 | N/A | 4480 |

In addition, for example, in a conventional wireless communication system, communication may be performed based on a terrestrial network including terminals located on the ground and base stations located on the ground. The terminal may access the network through a wireless connection. Here, when the terminal moves, the terminal may continuously receive the same service through another base station in the terrestrial network. After accessing the network, the terminal may access a specific service server through another wired or Internet network. In addition, the terminal may be provided with a service that connects to another terminal through the network via wired or wireless communication.

However, in a new wireless communication system, communication of a terminal may be supported not only through a terrestrial network but also through non-terrestrial networks (NTN). Here, NTN may refer to a network or a part of a network that uses a floating aerial or space vehicle equipped with a base station or a relay device. For example, NTN may support communication service between terminals based on satellites having communication functions on Low Earth Orbit (LEO) and Geostationary Earth Orbit (GEO). As another example, NTN may support communication service between terminals based on an aircraft having a communication function in Unmanned Aircraft Systems (UAS), but the present disclosure is not limited thereto.

In the following, terrestrial networks (TN) are described separately from non-terrestrial networks (NTN). That is, in the existing communication system, only terrestrial networks existed, so they did not need to be distinguished. On the other hand, in the following, NTN and TN are described separately as communication systems that enable communication between terminals based on NTN, and a method of supporting inter-terminal communication services based thereon is described.

For example, a wireless communication service between a terrestrial base station and a wireless terminal or between mobile base stations is described as a mobile service, but the present invention is not limited thereto. Also, a communication between mobile terrestrial base stations and at least one or more space base stations may be mobile satellite services. Also, a wireless communication service between mobile terrestrial base stations and space base stations or between mobile terrestrial base stations through at least one or more space base stations may be mobile satellite services, but the present invention is not limited thereto.

Hereinafter, a method of performing communication based on a wireless communication system that supports both a mobile service and a mobile satellite service will be described. For example, technologies for NTN have been introduced specialized in satellite communication, but NTN can also be introduced in a communication system of TN (e.g., 5G system) to operate like TN. Here, the terminal can support both NTN and TN simultaneously. The wireless communication system may need specific technologies for NTN in addition to long-term evolution (LTE) and new radio (NR) systems, which are radio access technologies (RATs), for a terminal that supports both NTN and TN simultaneously, and a method for this will be described below. For example, the following may be definitions of respective terms related to NTN and TN.

Non-terrestrial networks:

A network or part of a network using a mobile object floating in the air or in space equipped with a base station or relay equipment for communication.

NTN gateway:

A terrestrial base station or gateway located on the earth's surface and equipped with sufficient radio access equipment to connect to a satellite. Generally, an NTN gateway may be a transport network layer node (TNL).

Feeder link:

### Radio Link Between NTN Gateway and Satellite

Geostationary Earth orbit (GEO):

A circular orbit at an altitude of 35,786 km above the Earth's equator, with an orbital period matching the Earth's rotational period, in the same direction as the Earth's rotation. Objects or satellites in this orbit appear to be stationary when viewed from the Earth, as they complete one orbit in the same time the Earth takes to rotate once on its axis.

Low Earth Orbit (LEO):

An orbit between 300 km and 1500 km above the Earth.

Medium Earth Orbit (MEO):

### Orbit Existing Between LEO and GEO

Unmanned Aircraft Systems (UAS):

Generally, the system operating on the ground at 8 km to 50 km may include High Altitude Platforms (HAPs). The unmanned aircraft system may include at least one of Tethered UAS (TUA), Lighter Than Air UAS (LTA), and Heavier Than Air UAS (HTA) systems.

Minimum elevation angle:

elevation angle required for a terrestrial terminal to direct to a satellite or UAS base station existing in the air

Mobile Services:

Wireless communication service between a terrestrial base station and a wireless terminal or between mobile base stations.

Mobile Satellite Services:

It may be a wireless communication service between mobile terrestrial base stations and one or more space base stations or between mobile terrestrial base stations and space base stations or between mobile terrestrial base stations via one or more space base stations.

Non-Geostationary Satellites:

It may be a satellite orbiting the earth with a period of about 1.5 hours to 10 hours on LEO and MEO orbits.

On-board processing:

Digital processing for an uplink RF signal loaded on a satellite or non-terrestrial equipment

Transparent payload:

It may mean changing a carrier frequency of an uplink RF signal and filtering and amplifying it before transmitting it through a downlink.

Regenerative payload:

Transforming and amplifying the uplink RF signal before transmitting it through the downlink, wherein the transformation of the signal may include digital processing such as decoding, demodulation, re-modulation, re-encoding and filtering.

On-board NTN base station (On board NTN gNB):

In the regenerative payload structure, it may refer to an on-board satellite in which a base station (gNB) is implemented.

On-ground NTN base station:

A terrestrial base station in which a transparent payload structure is implemented.

One-way latency:

The time taken for a radio signal to travel from a wireless terminal to a public data network or from a public data network to a wireless terminal.

Round Trip Delay (RTD):

It may be a time for an arbitrary signal to reach from a wireless terminal to an NTN-gateway or from the NTN-gateway to the wireless terminal and then return. In this case, the returning signal may be a signal including a different form or message from the arbitrary signal.

Satellite:

It may be a space-based mobile body equipped with a wireless communication transceiver capable of supporting a transparent payload or a regenerative payload, and may generally be located on LEO, MEO, or GEO orbits.

Satellite beam:

beam generated by the antenna of the onboard satellite

Service link:

### Satellite-to-UE Radio Link

User Connectivity:

A capability for setting up and maintaining data/voice/video transmission between a network and a terminal.

User Throughput:

### Data Transfer Rate Provided to the Terminal

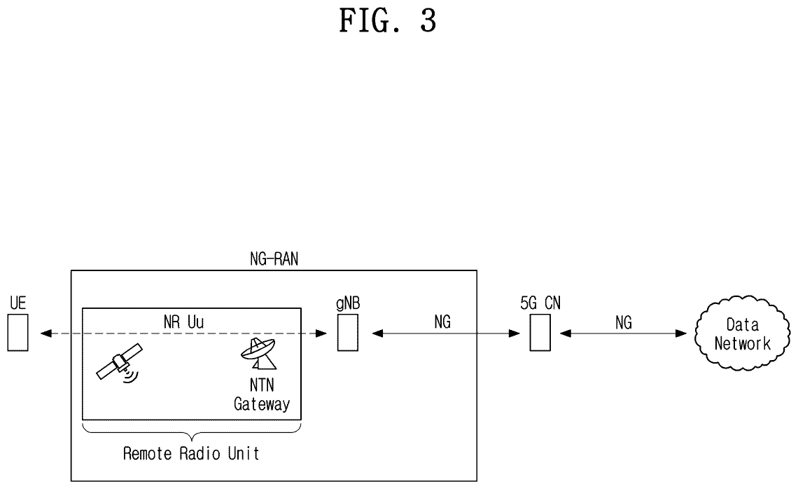

FIG. 3 illustrates a non-terrestrial network (NTN) including a transparent satellite to which the present disclosure may be applied.

Referring to FIG. 3, a terminal included in the NTN may include a terrestrial network terminal. For example, terminals of the NTN and the TN may include manned or unmanned mobile bodies such as ships, trains, buses, or airplanes, and may not be limited to a specific form. Referring to FIG. 3, a transparent satellite payload generated through a network including a transparent satellite may be implemented in a manner corresponding to an RF repeater.

More specifically, a network including a transparent satellite may perform frequency conversion and amplification on a radio signal received in all directions of uplink and downlink, and may transmit the radio signal. Therefore, the satellite may perform a function of relaying the NR-Uu radio interface including both the feeder link and the service link, and the NR-Uu radio interface will be described later.

As another example, referring to FIG. 3, a satellite radio interface (SRI) on a feeder link may be included in the NR-Uu interface. That is, the satellite may not be a termination of the NR-Uu interface. Here, the NTN gateway may support all functions needed to forward the signals defined in the NR-Uu interface. For example, several transparent satellites may be connected to the same base station on the ground. That is, a configuration in which a plurality of transparent satellites are connected to one terrestrial base station is also possible. The base station may be an eNB or a gNB, but may not be limited to a specific form.

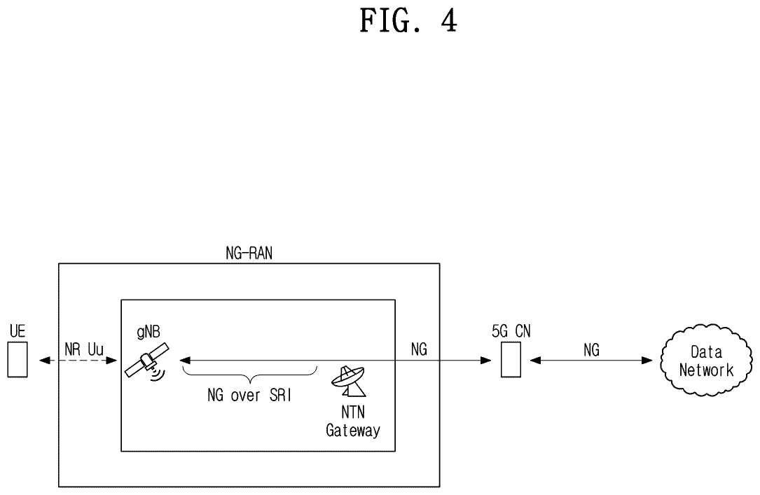

FIG. 4 illustrates a NTN including regenerative satellites without Inter-Satellite Links (ISL) to which the present disclosure may apply.

Referring to FIG. 4, the NTN may include a regenerative satellite. Here, the regenerative satellite may mean that a base station function is included in the satellite. For example, a regenerative satellite payload generated through a network including the regenerative satellite may be implemented in a manner of regenerating a signal received from the ground.

More specifically, the repeater satellite may receive a signal from the ground based on the NR-Uu radio interface on the service link between the UE and the satellite. As another example, the repeater satellite may receive a signal from the ground through an SRI (Satellite Radio Interface) on a feeder link between NTN gateways. Here, the SRI (Satellite Radio Interface) may be defined in a transport layer between the satellite and the NTN gateway. The transport layer may refer to a layer among the OSI 7 layers. That is, based on the repeater satellite, a signal from the ground may be modified based on digital processes such as decoding, demodulation, re-modulation, re-encoding, and filtering, and the like, but the signal is not limited thereto.

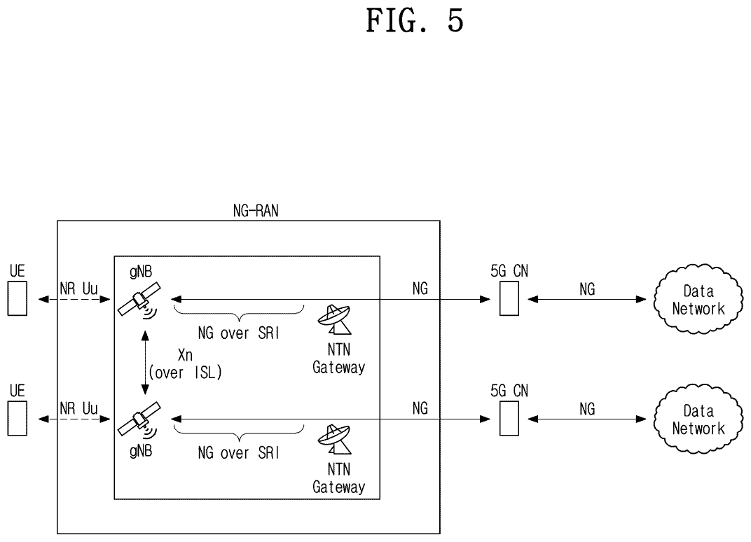

FIG. 5 illustrates an NTN including regenerative satellites with ISL to which the present disclosure may be applied.

Referring to FIG. 5, the ISL may be defined at the transport layer. As another example, the ISL may be defined as a radio interface or an optical interface, and is not limited to a specific embodiment. Here, the NTN gateway may support all functions of the transport protocol. Also, each of the regenerative satellites may become a base station, and a plurality of regenerative satellites may be connected to the same 5G core network on the ground.

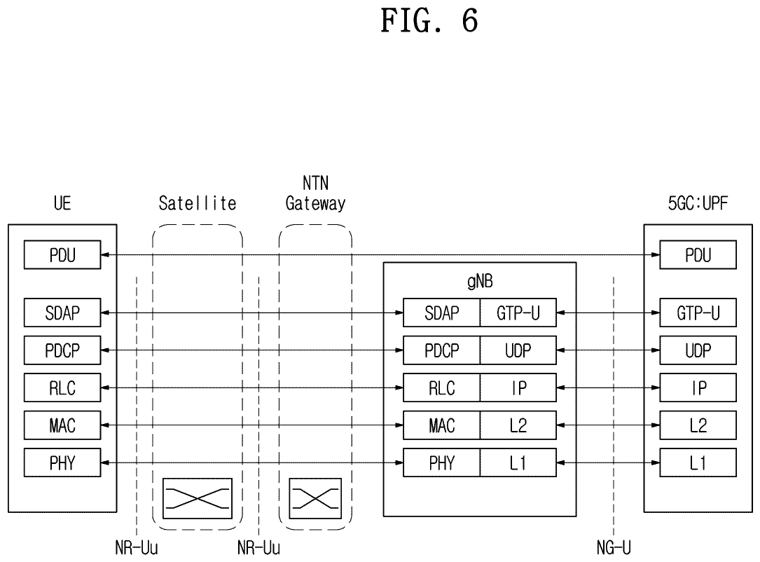

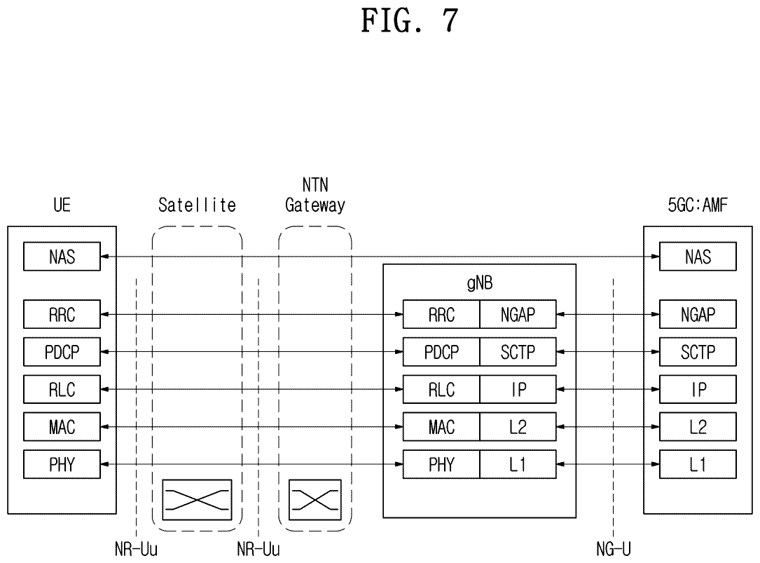

FIG. 6 illustrates a user plane (UP) protocol stack structure in an NTN including a transparent satellite to which the present disclosure may be applied. Further, FIG. 7 illustrates a control plane (CP) protocol stack structure in an NTN including a transparent satellite to which the present disclosure may be applied.

The NR Uu interface may be an interface defined as protocols for radio access between a terminal and a base station in an NR system. In this case, the NR Uu interface may include a user plane defined as protocols for user data transmission, including NTN. Also, the NR Uu interface may include a control plane defined as protocols for transmitting signaling including radio resource control information, etc., including NTN. For example, a medium access control (MAC) layer is configured based on radio link control (RLC), packet data convergence protocol (PDCP), service data adaptation protocol (SDAP), and radio resource control (RRC), and a protocol of each layer may be defined based on NR among 3GPP RAN-related standards, but the present disclosure is not limited thereto.

For example, FIG. 6 may be an UP protocol stack structure based on a transparent satellite. That is, the satellite and the NTN gateway may perform only frequency conversion and amplification on a transparently received radio signal and transmit the signal. FIG. 7 may be a CP protocol stack structure based on a transparent satellite. That is, the satellite and the NTN gateway may perform only frequency conversion and amplification on a transparently received radio signal.

Based on the above, a wireless communication system supporting communication between UEs with NTN and TN can be considered. Here, for example, the NTN may have a larger roundtrip time (RTT) between the UE and the BS compared to the existing TN. Therefore, the UE needs to store data to be transmitted through the uplink and downlink in a buffer for a longer time due to the increased RTT from the UP viewpoint. That is, the UE needs to store more data in the buffer. Accordingly, the UE may require a memory having a larger capacity than before, which will be described later.

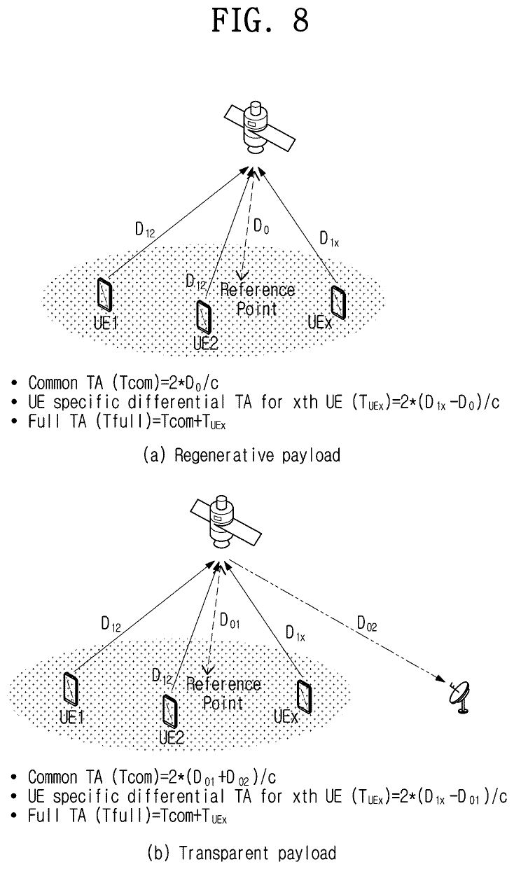

FIG. 8 illustrates a timing advance calculation method to which the present disclosure may apply. As described above, since a satellite included in the NTN is located in the air, a signal round trip time (RTT) may be long. For example, LEO may exist at an altitude of 300 km to 1200 km, and GEO may be located at an altitude of 36,000 km or more above the equator. Therefore, in the NTN, a propagation delay may be much larger than that of the TN. On the other hand, since the NTN is located in the air, a cell coverage may be larger than that of a terrestrial network.

That is, since the RTT and cell coverage of the NTN may be different from those of the TN, a method of acquiring time synchronization for uplink transmission in the NTN needs to be newly defined. For example, FIG. 8 may be a method of calculating a TA value generated according to a satellite payload type.

More specifically, FIG. 8(a) may be a method of calculating a TA value when the satellite payload type is a regenerative payload. Also, FIG. 8(b) may be a method of calculating a TA value when the satellite payload type is a transparent payload.

Here, for initial access and continuous maintenance of a timing advance (TA) value, a case in which the UE knows the satellite ephemeris and the UE's location may be considered. Here, the satellite ephemeris may mean a distance between each satellite and a receiver and location information of each satellite. For example, the UE may acquire and apply the TA value by itself (hereinafter, option 1). As another example, the UE may receive an indication of TA compensation and correction from the network (hereinafter, option 2).

For example, referring to FIG. 8(a), when the satellite payload type is a regenerative payload, the satellite may directly perform the role of a base station. In this case, the UE may calculate a TA value required for uplink transmission including a PRACH (physical random access channel). The UE may calculate a common TA value (T_{com}) and a UE-specific TA value (T_{UEx}). For example, the common TA value (T_{com}) may be a TA value required for all UEs due to the large cell coverage of the NTN and the long round trip time (RTT). That is, since the NTN is located in the air and has a relatively long distance compared to the distance between UEs, a common TA value (T_{com}) considering a long round trip time (RTT) in the cell coverage may be required. In addition, the UE-specific TA value (T_{UEx}) may be a value generated due to the different location of each UE within the cell coverage. If the UE knows the location of the satellite at a specific time through satellite ephemeris that has been pre-stored or received from the NTN, and knows the location of the UE through a function such as GNSS, the UE may calculate the distance between the satellite and the UE at a specific time, acquire the TA value by itself, correct the TA value, and determine the TA value.

Through the above, the UE may perform uplink timing alignment between UEs received from the BS with a whole TA compensation.

As another example, the UE may perform downlink and uplink frame timing alignment on the network side. As shown in FIG. 8(b), when the satellite payload type is a transparent payload, the satellite may perform filtering and amplification of a radio signal and transmit the signal to the NTN gateway. That is, the satellite may operate like an RF repeater. In this case, it may be necessary to change the NTN gateway based on the continuous movement of the satellite. In FIG. 8(b), a common TA value (T_{com}) may be determined based on a sum of a distance D01 between a reference point and the satellite and a distance D02 between the satellite and the NTN gateway. In this case, the feeder link may be changed as the NTN gateway is changed based on the movement of the satellite. That is, the distance between the satellite and the NTN gateway may be changed based on the changed feeder link. Therefore, the common TA value may be changed, and it is necessary to update the corresponding UE. In addition, when the network sets an offset between the downlink frame timing and the uplink frame timing, it is additionally necessary to consider a case in which a TA value generated due to the feeder link is not corrected by the entire TA compensation method. In addition, when each UE can calculate only a different TA value (T_{UEx}), the UE needs to identify one reference point for each beam or cell and needs to transmit information on the reference point to other UEs. When the network sets an offset between the downlink frame timing and the uplink frame timing, the network needs to manage offset information regardless of the satellite payload type. Here, for example, the network may provide a value for TA correction to each UE, and the network is not limited to the above-described embodiment.

As another example, a method (option 2) of indicating TA compensation and correction in the network may be considered. In this case, a common TA value may be generated based on common factors for a propagation delay shared by all UEs located within the beam or cell coverage of the satellite. The network may transmit the common TA value to the UEs for each beam or cell of each satellite based on a broadcast scheme. The common TA value may be calculated in the network assuming at least one reference location for each beam or cell of each satellite. Also, a UE-specific TA value (T_{UEx}) may be determined based on a random access procedure defined in a conventional communication system (e.g., Release 15 or Release 16 of the conventional NR system). In this case, for example, when applying a long TA value and a negative TA value, a new field may be needed for a random access message. For example, when the network provides a timing change rate to the UE, the UE may support TA value correction based on the timing change rate.

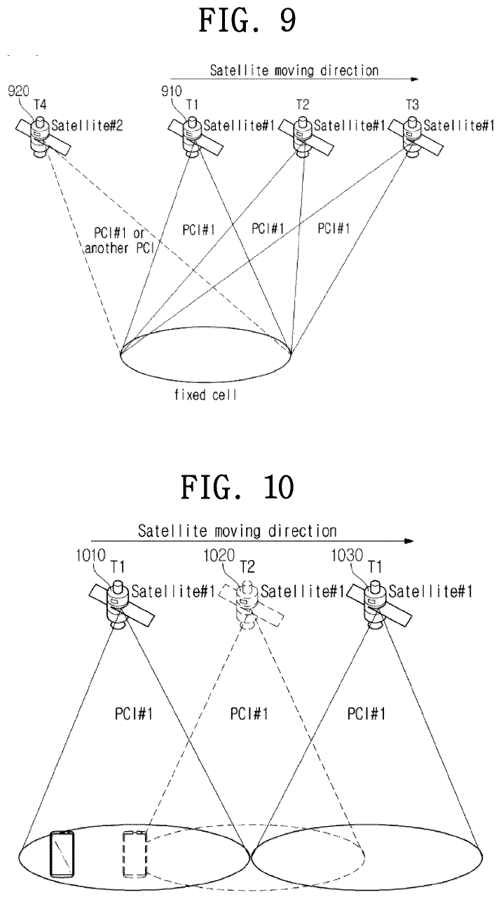

FIG. 9 illustrates a fixed cell scenario (earth fixed cell scenario) to which the present disclosure may apply.

Referring to FIG. 9, a fixed cell may be a cell in which a signal is transmitted from a satellite to a fixed location. For example, since a satellite moves over time, it is necessary to vary the antenna and beam so that the service coverage is fixed to a specific location, thereby maintaining the fixed cell. Here, for example, in FIG. 9, satellite 1 910 may maintain a fixed cell while varying the antenna and beam during T1 to T3. Here, when a specific time (T4) elapses, satellite 1 can no longer service the corresponding location, so service can be provided at the corresponding location by satellite 2 920, thereby maintaining service continuity. At this time, the beam or cell of satellite 2 920 that services the same location as the location serviced by satellite 1 910 before time T4 (i.e., T1 to T3) may maintain the characteristics of the beam or cell of satellite 1 910, and is not limited to the above-described embodiment.

For a more specific example, when services are provided by the satellite 1 910 and the satellite 2 920, at least one of a physical cell ID (PCI) value and system information may be maintained to be the same. That is, it may be set based on satellites on LEO and MEO orbits, excluding GEO, which can change the angles of antennas and beams, as cells with fixed service coverage.

On the other hand, FIG. 10 illustrates an earth moving cell scenario to which the present disclosure may apply. For example, a cell having a moving service coverage may be an earth moving cell.

For example, referring to FIG. 10, satellite 1 1010, satellite 2 1020, and satellite 3 1030 may provide services with respective cells having different PCIs. Here, the antenna and beam through which the satellite transmits a signal to the ground are fixed, and a form in which the service coverage moves as the satellite moves over time may be referred to as an earth moving cell. The earth moving cell may be configured based on satellites on LEO and MEO orbits except for GEO, among which the angles of antennas and beams are fixed. Here, the corresponding satellites may have advantages of being low-priced and having a low failure rate compared to satellites capable of adjusting angles of antennas and beams.

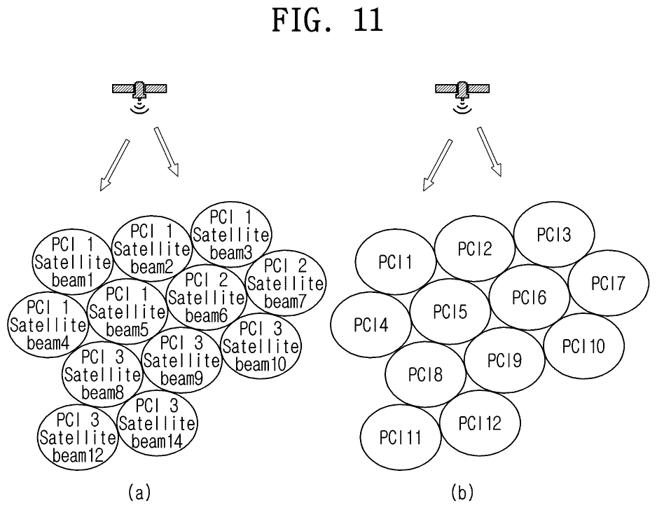

FIG. 11 illustrates a method of mapping a physical cell identity (PCI) to satellite beams to which the present disclosure may apply.

For example, a PCI may refer to an index that can logically identify one cell. That is, beams having the same PCI value may be included in the same cell. For example, referring to FIG. 11(a), a PCI may be allocated to several satellite beams. On the other hand, referring to FIG. 11(b), one PCI may be allocated to each satellite beam in one satellite. For example, a satellite beam may consist of one or more Synchronization Signal Block (SS/PBCH block, SS) beams. One cell (or PCI) may consist of up to L SSBs. Here, L may be 4, 8, 64, or 256 according to the size of the frequency band and/or subcarrier band, but is not limited to the above-described embodiment. That is, L may use one or a plurality of SSB indexes for each PCI, similar to a terrestrial network (TN) which is an existing communication system (NR system). Through this, SSBs transmitted through different beams can be distinguished, and the SSB index can be logically defined as an antenna port or physically divided and formed with a beam mapping.

For example, a terminal capable of accessing the NTN may be a terminal supporting a Global Navigation Satellite System (GNSS) function. However, a terminal capable of accessing the NTN may include a terminal that does not support GNSS. As another example, the NTN may be a terminal that supports the GNSS function but is not able to obtain location information through the GNSS, and the NTN may also support such a terminal, which is not limited to the above-described embodiment.

As described above, the terminal may perform communication through the NTN. For example, the terminal may be provided with a non-terrestrial network-based service based on 5G/B5G NTN. Through this, the terminal can be freed from regional, environmental, spatial, and economic constraints on wireless access services (e.g., LTE, NR, WiFi, etc.) based on the installation of terrestrial network equipment. For example, advanced wireless access technologies provided on terrestrial networks may be applied to non-terrestrial network platforms (e.g., satellites and UAVs) based on the above. Through this, various wireless access service products and technologies can be provided with advanced network technologies.

The NTN platform may be operated as a kind of mirror role by mounting a function of relaying the NR signal in space or at a high altitude or a base station (gNB, eNB) function. For example, the NG-RAN-based NTN architecture may implement functions with a “Transparent payload-based NTN” and “Regenerative payload-based NTN” structure, as mentioned above.

Also, for example, NTN technology may be used for wider coverage and more radio access services as an extended network structure and technology of 5G IAB (Integrate Access and Backhaul) architecture. The integration of NTN and terrestrial network may ensure service continuity and scalability of the 5G system.

As a specific example, the NTN and TN integrated network may provide significant gains in 5G target performance (e.g., user experience data rate and reliability) in urban and suburban areas. As another example, the NTN and TN integrated network may ensure connectivity not only in highly dense areas (e.g., concert halls, sports stadiums, shopping centers, etc.) but also in fast-moving objects such as airplanes, high-speed trains, vehicles, and ships. As another example, the NTN and TN integrated network may use a multi-connection function to simultaneously utilize data transmission services from the NTN network and the TN network. At this time, by selectively utilizing a better network according to traffic characteristics and traffic loading degree, both efficiency and economy of the 5G wireless transmission service can be obtained.

A terminal located in a general plain area may connect to the NTN network and the TN network at the same time to use a wireless data service. Also, the terminal may be connected to one or more NTN platforms (e.g., two or more LEO/GEO satellites) at the same time to provide a wireless data access service for a poor environment or area that is difficult to support in the TN network. Through this, the terminal can be utilized in connection with various services. In particular, the integrated NTN network and TN network can improve the reliability of autonomous driving services and perform efficient network operation, and are not limited to the above-described embodiments.

Here, for example, LTE mobile communication-based V2X technology or IEEE 802.11p standard-based standard technology may have similar limitations on the services that can be provided. The LTE V2X standard may be provided to meet the requirements defined on C-ITS (e.g., a time delay of about 100 ms, a reliability of about 90%, and generating a message of several tens to several hundreds of bytes about 10 times per second). Therefore, a new V2X service requiring low latency, high reliability, high-capacity data traffic, and improved location positioning may be needed. At this time, for example, based on the above, standardization of 5G wireless access technology (e.g., NR (New Radio)) is in progress. Also, for example, standardization of various numerology, frame structure, and corresponding L2/L3 protocol structure is in progress so that requirements of new services can be handled more flexibly than LTE. Based on the above, by introducing sidelink wireless access technology based on 5G mobile communication technology, it may be possible to support enhanced V2X services such as autonomous driving or remote driving, and NTN network may be utilized for this purpose.

As another example, an NTN network may be utilized to support IoT services for poor environments and areas not covered by a terrestrial network. For example, IoT devices may frequently need to perform wireless communication with minimal power consumption in poor channel environments (e.g., mountains, deserts, or seas) according to their purpose of use. Conventionally proposed cellular-based technologies may mainly aim at mobile broadband (MBB) services. Therefore, they may be inefficient in providing IoT services in terms of radio resource utilization and power control, and may not support flexible operations. Also, for example, conventional non-cellular-based IoT technologies may have limitations in providing various IoT services due to limited mobility support and coverage. In consideration of the above, an NTN network may be applied, and services may be improved therewith.

Also, for example, if a 5G mobile communication-based sidelink technology is applied through the NTN network, it can provide users with wide coverage and mobility in a high-efficiency wireless communication method, compared to the current Bluetooth/Wi-Fi-based wearable devices. Additionally, it can be differentiated from existing communication standards in applications requiring high data rates and mobility support using wearable devices (e.g., wearable multimedia services).

As another example, public safety communication networks may be improved and disaster communication coverage may be expanded through an NTN network. For example, high reliability and low latency technologies of a 5G mobile communication system may provide public services such as disaster response through the NTN network. For example, mobile broadband services may be supported in deserts, high mountains, or the like by using a moving base station such as a drone that supports 5G mobile communication. That is, when the NTN network is applied to a public service, disaster communication coverage may be expanded by covering various areas.

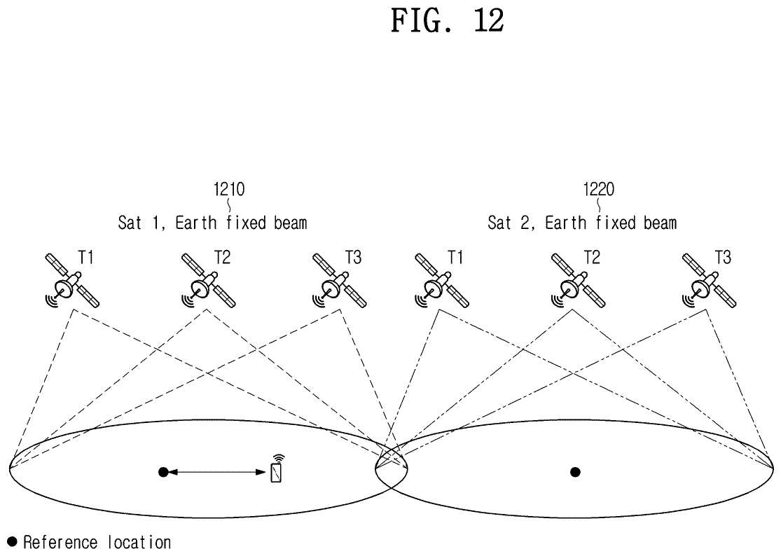

FIG. 12 is a diagram illustrating a reference location to which the present disclosure is applicable. Referring to FIG. 12, satellites 1210 and 1220 having an earth-fixed beam may provide a service for a specific time for a fixed location based on the fixed beam. In the NTN environment, since the distance between the UE and the satellite is large, signal strength may be similar within a cell. Accordingly, the RRC idle state UE may consider a reference location as a condition for performing neighboring cell measurement for cell reselection. That is, the RRC idle state UE may perform cell measurement for cell reselection based on the distance between the UE and the reference location. Specifically, a UE located within the coverage of satellite 1 (Sat 1, 1210) may obtain reference location information through system information from a network. The UE may determine the distance between the UE and the reference location based on the location of the UE. Here, when the distance between the UE and the reference location is greater than a distance threshold, the UE may recognize that the current location of the UE is at the cell edge and perform measurement on a neighboring cell. That is, the UE may perform cell measurement for cell reselection in consideration of the distance between the reference location and the UE.

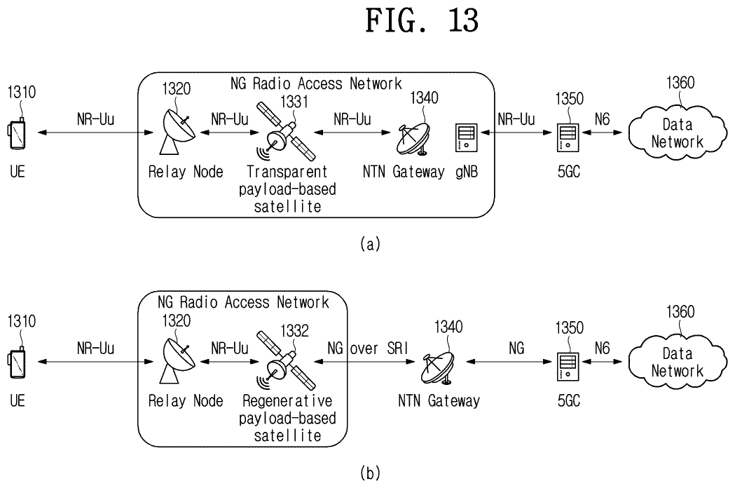

FIG. 13 is a diagram illustrating an NTN structure providing a relay function that may be applied to the present disclosure. Referring to FIG. 13, an NTN structure providing a relay function may be considered. Referring to FIG. 13(a), a terminal 1310 may communicate with a relay node 1320 through a Uu interface. Here, the relay node 1320, a transparent payload-based satellite 1331, and an NTN gateway and a gNB 1340 may be configured as a radio access network (RAN). That is, in FIG. 13(a), when a relay function is provided based on the transparent payload-based satellite 1331, the RAN may include the relay node 1320, the NTN gateway, and a terrestrial base station. Thereafter, the terrestrial base station 1340 may communicate with a core network 1350, and the core network 1350 may be connected to a data network 1360. As another example, referring to FIG. 13(b), the terminal 1310 may communicate with the relay node 1320 through the Uu interface. Here, the relay node 1320 and a regenerative payload-based satellite 1332 may be configured as the RAN. That is, in FIG. 13(b), when a relay function is provided based on the regenerative payload-based satellite 1332, the RAN includes the relay node 1320 and the regenerative payload-based satellite 1332, and may communicate with the core network 1350 through the NTN gateway 1340. Also, the core network 1350 may be connected to the data network 1360. That is, the regenerative payload-based satellite 1332 may perform a role of a base station, but may not be limited thereto.

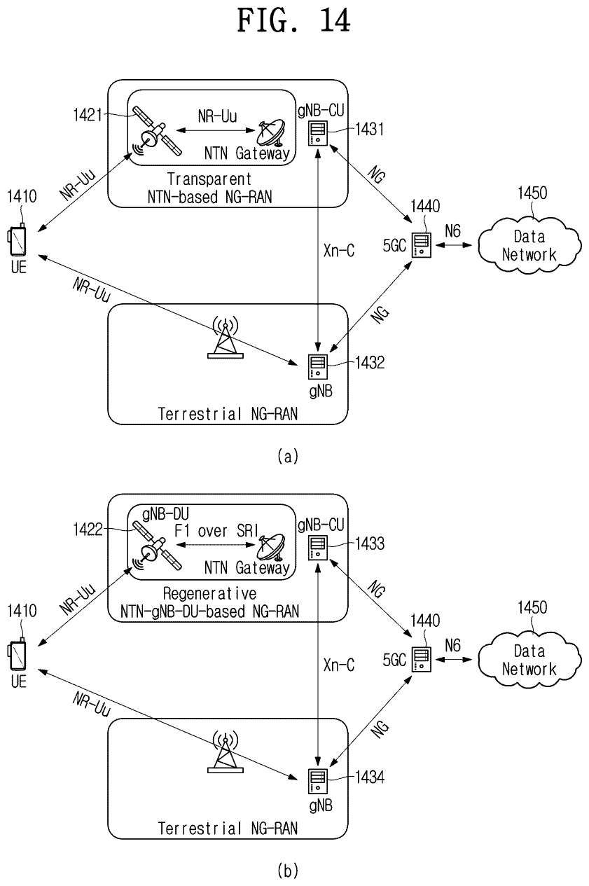

FIG. 14 illustrates an NTN structure providing a multi-connectivity function applicable to the present disclosure.

The terminal may perform multi-connection based on NTN/TN and NTN/NTN. For example, referring to FIG. 14, the terminal may perform multi-connection through NTN and TN. As a specific example, referring to FIG. 14(a), the terminal 1410 may perform multi-connection through a base station 1431 configured based on a transparent payload-based satellite 1421 and a TN base station 1432. Here, each base station 1431 and 1432 may be connected to a core network 1440, and the core network 1440 may be connected to a data network 1450. As another example, referring to FIG. 14(b), the terminal 1410 may be connected based on a regenerative payload-based satellite 1422. Here, the regenerative payload-based satellite 1422 is a gNB DU (distributed unit), and the gNB DU may be controlled by a gNB CU 1433. Multi-connection may be performed through the gNB CU 1433 and the TN base station 1434. Here, each base station 1433 and 1434 may be connected to the core network 1440, and the core network 1440 may be connected to the data network 1450.

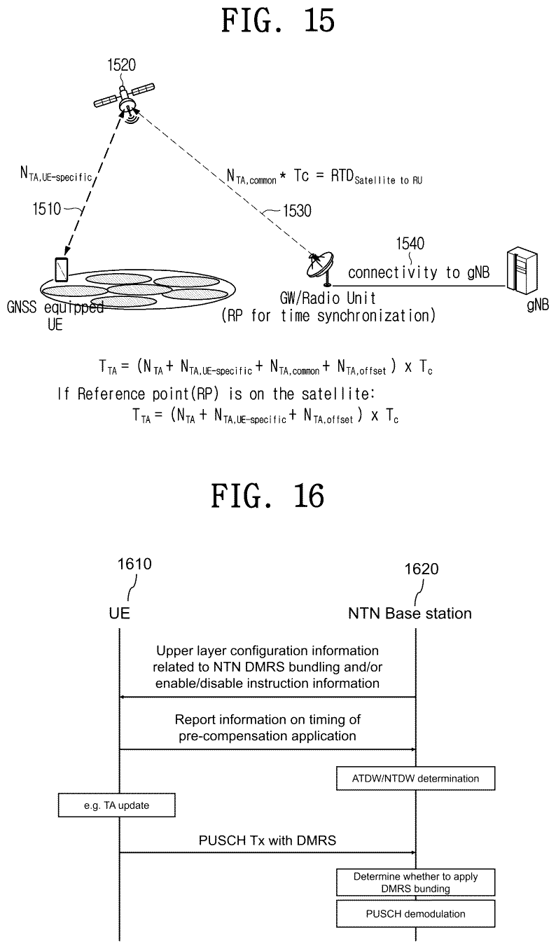

FIG. 15 is a diagram illustrating a TA configuration method in an NTN environment applicable to the present disclosure. For example, signals transmitted by UEs in one cell need to arrive at the base station at the same time. That is, the base station needs to acquire signals from UEs in one cell at the same time. To this end, UEs in one cell may apply a timing advance (TA) value in consideration of the distance from the base station. For example, a UE far from the base station in one cell may transmit a signal in advance based on the TA value, and a UE close to the base station in one cell may transmit a signal based on a TA value smaller than the above-described value. Through this, the base station may receive signals from a plurality of UEs in one cell simultaneously. For example, in the NTN environment, a signal transmitted by a UE may be delivered to the base station via a satellite. Therefore, when determining the TA value, it is necessary to consider a service link between the UE (1510) and the satellite (1520) and a feeder link between the satellite (1520), the gateway (1530), and the base station (1540).

As a specific example, referring to FIG. 15, Equation 3 below may be applied to a terminal 1510 in the NTN system. For example, the terminal 1510 in the NTN system may be in an RRC idle/inactive state or an RRC connected state, and is not limited to a specific form.

$${T}_{TA} = ( {N}_{TA} + {N}_{TA , UE - specific} + {N}_{TA , common} + {N}_{TA , offset} ) \times {T}_{c} \qquad [ Equation 3 ]$$

Here, denotes a TA command value indicated by the network, and denotes a fixed offset value according to a frequency domain in a terrestrial network and may include a TA margin. Also, may be a basic time unit. For example, at least one of a physical random access channel (PRACH), a TA command field value in msg2/msgB of a random access procedure, and a medium access control (MAC) control element (CE) TA command value may be set to 0, but may not be limited to the corresponding embodiment.

Also, in Equation 3, may be a value estimated by the UE for a priori compensation of the service link delay. In Equation 3, is a common TA value controlled by the network and may include a timing offset. For example, the value of may be 0, but the present disclosure is not limited thereto.

In the NTN environment, the propagation delay between the network and the terminal location may change very rapidly. For example, the maximum delay change rate for a 600 km LEO may be +/−40 us/sec, but is not limited to this embodiment. For example, in the NTN environment, a closed loop MAC-CE indication-based TA maintenance method may have a large DL signaling overhead due to tracking a large TA change based on satellite movement. Also, the terminal-specific TA ( ) may be derived from the service link by the terminal location and satellite orbit force, but the drift of the common TA of the feeder link part may not be obtained by the terminal. Here, since the validity period of the common TA drift rate is much longer than the common TA, there is a need to apply the common TA drift rate in the NTN environment to reduce signaling overhead and avoid frequent SIB1 decoding.

For example, N_{TA,common} can be derived considering Delay_{common} (t) of Equation 4 below. In Equation 4, common TA parameters provided by the network to the UE at a specific time (t_{epoch}) may include three values: TA common, TA common drift, and TA common drift variant. The UE may calculate a one-way propagation delay at time t through Equation 4.

$${Delay}_{common} ( t ) = \frac{1}{2} ( {T}_{TA , common} ( {t}_{epoch} ) + {T}_{TA , common , drift} ( {t}_{epoch} ) \times ( t - {t}_{epoch} ) + {T}_{TA , common , drift , variant} ( {t}_{epoch} ) \times {( t - {t}_{epoch} )}^{2} ) \qquad [ Equation 4 ]$$

As another example, a terminal time alignment timer may be configured in the NTN environment. For example, a legacy time alignment timer may be used for a closed loop. The time alignment timer may mean a maximum time that the UE can maintain uplink synchronization without receiving a tracking area code (TAC) from the base station. Upon receiving the MAC TAC, the UE may update N_{TA} and restart the time alignment timer. On the other hand, if the UE does not perform the update until the time alignment timer expires, it may determine that uplink synchronization is lost.

For example, a new validity timer configured in a UE-specific TA for an NTN may be set. Here, the new validity timer may be a timer configured in the UE-specific TA for the NTN, and may not be limited to a specific name and may be used with another name. As a specific example, the new validity timer may mean a maximum time during which the UE may track a round trip delay (RTD) on a service link without acquiring new ephemeris data to be used for UE-specific TA estimation. For example, the new validity timer may be restarted when new ephemeris data of the UE is received. On the other hand, if the UE cannot use new information or additional assistance information within the new validity timer, the UE may determine that uplink synchronization is lost. That is, if the UE fails to acquire satellite ephemeris data or common TA parameter information, it may determine that uplink synchronization is lost.

As another example, a validity timer may be configured for a common TA for NTN. Here, the validity timer for the common TA for NTN may mean a maximum time for which the UE can track the common RTD without acquiring new support information (e.g., common TA, common TA drift rate) to be used for common TA estimation, but may not be limited to this name. The UE may restart the timer upon receiving the above-described new support information. On the other hand, if the UE fails to acquire the support information until the timer expires, it may determine that uplink synchronization is lost.

As another example, a validity timer configured in the network for satellite orbit information may mean a maximum time for which the UE can apply the satellite orbit information without acquiring new satellite orbit information. The validity timer configured in the network for satellite orbit information may be referred to by another name, and is not limited to a specific embodiment. For example, the satellite orbit information may be valid only within a limited time. The satellite orbit information may be information used to calculate a position of the satellite at a specific moment. Variability within the satellite orbit may be updated based on the above-described information. Also, the UE needs to acquire the satellite orbit information for UE-specific TA update, and may use an orbit propagator method to predict a specific TA value during a specific time. The orbit propagator method may mean a method of calculating a position and velocity of a phase on an earth orbit based on compatible elements. Also, the UE may determine that the newly acquired satellite orbit data is valid only for one interval based on the propagator mode and a maximum tolerable error on the estimation of N_{TA, UE-specific}, and is not limited to a specific embodiment.

In the following, a method of NTN-specific PUSCH DMRS bundling is described. Specifically, the NTN-specific PUSCH DMRS bundling needs to be performed in consideration of NTN channel and installation/use scenario environment and requirements, and the following describes a scheme for this.

DMRS bundling may be applied for coverage extension in uplink. That is, DMRS bundling may be used for coverage extension on the uplink where coverage constraints exist. For example, DMRS bundling may be used for estimating channel information through DMRS based on that a plurality of time units (e.g. slot, symbols, subframe, etc.) or a time window in the time domain has uniform phase continuity and power consistency, but the method may not be limited thereto.

For example, DMRS bundling may maximize data/control channel decoding performance by performing channel estimation based on DMRS or coherent DMRS on a plurality of time slots, and thus coverage may be expanded. The receiving end may perform joint channel estimation of DMRS on a plurality of time slots, and thus channel estimation accuracy may be increased. Through the above, coverage may be expanded. Also, the data/control channel may be repeatedly transmitted on a plurality of slots. Here, when repetitive transmission of the data/control channel and DMRS bundling are together applied, a coverage expansion effect may be maximized.

For example, in the NTN system, channel estimation performance optimization may be required due to the long distance between the satellite and the terminal. In particular, uplink transmission may need to be optimized in consideration of power consumption of the terminal. Here, a DMRS bundling method for a PUSCH channel, which is an uplink data physical channel, may be required, and a method for this is described below.

In the NTN system environment, the uplink coverage of the UE may be limited. The UE may perform uplink transmission based on DMRS bundling. Specifically, the UE may perform uplink transmission based on DMRS bundling to cope with attenuation and distortion of a radio channel transmitted to the BS. For example, DMRS bundling may be a joint channel estimation scheme, but may not be limited to a specific name.

For example, in the NTN scenario, the positions of the satellite and the UE may be moved. Here, the UE may be implemented to perform a pre-compensation operation for timing and frequency offset based on the movement of the satellite and the UE. Also, for example, to support DMRS bundling, the above-mentioned phase continuity and power consistency may be required to be maintained. For example, if DMRS bundling is enabled, pre-compensation may not be expected within a time domain window (TDW). For example, TDW may be configured for DMRS bundling application. As a specific example, TDW may be divided into a nominal TDW (NTDW) and an actual TDW (ATDW). The NTDW may be provided to the UE by the base station or may be a predetermined value. The NTDW may be configuration information about a time window provided when DMRS bundling is activated. On the other hand, the ATDW may be a time window in which actual phase continuity and power consistency are maintained and DMRS bundling is substantially applied within the NTDW. Therefore, it is necessary to ensure that phase continuity and power consistency are always maintained within the ATDW for effective DMRS bundling.

However, an event in which phase continuity and power consistency cannot be maintained may occur in the terminal. For example, when a TA value is updated in the terminal, phase continuity and power consistency may not be maintained. For example, the determination of the TA value in the NTN has been improved in consideration of the NTN channel environment, and accordingly, the uplink synchronization performance of the NTN system has been improved. For example, the TA value in the NTN may consist of a common TA and a UE-specific TA, as described above. Here, the common TA may correspond to a feeder link, and the UE-specific TA may be a value corresponding to a round trip time (RTT) on a service link. The common TA may be a value provided by the base station. Here, the terminal may update the provided common TA value when the channel environment based on the movement of the terminal or satellite changes. For example, the terminal may update the common TA using parameters of TACommonDrift and TACommonDriftVariation in response to variability based on the movement of the terminal or satellite, but the present disclosure is not limited to this embodiment. For example, when the common TA is updated, phase continuity and power consistency may not be maintained. Therefore, in the above situation, it may be difficult to guarantee the DMRS bundling effect.

Also, for example, a UE-specific TA may be a value for an RTT on a service link and may be derived by the UE. For example, updating of the UE-specific TA value may be determined by UE implementation, but may not be limited to a specific embodiment. For example, when the UE-specific TA is updated, phase continuity and power consistency may not be maintained. Therefore, in the above situation, it may be difficult to ensure the DMRS bundling effect.

In consideration of the above, the UE needs to recognize update application time information of the common TA and the UE-specific TA with the base station. That is, the TA update timing and frequency information need to be indicated in consideration of DMRS bundling, and it is necessary to determine the configuration for the TDW and the ATDW in consideration of the above information.

In the following, a method for determining ATDW/NTDW related to applying DMRS bundling for PUSCH transmission in the NTN system will be described in consideration of the above.

For a specific example, the ATDW/NTDW may be determined based on when a pre-compensation update procedure that causes phase discontinuity and power inconsistency is performed by the UE. Here, the pre-compensation update procedure may include a TA update, a validity duration update, an epoch time reception/update, and other update procedures, which may not be limited to a specific procedure. The UE may transmit, to the base station, information on a time point at which the pre-compensation update procedure is performed, which will be described later. As another example, the base station may provide the UE with an NTN-specific configuration (or indication) related to a time point at which the UE performs the pre-compensation update procedure, which will be described later.

FIG. 16 illustrates a method of applying PUSCH DMRS bundling based on a pre-compensation update report applicable to the present disclosure.

Referring to FIG. 16, the terminal 1610 may be provided with at least one of upper layer configuration information related to NTN DMRS bundling and DMRS bundling enable/disable indication information from the NTN base station 1620 in advance. For example, if the terminal receives an indication of DMRS bundling enable, it may apply DMRS bundling, and if it receives an indication of DMRS bundling disable, it may not apply DMRS bundling.

When DMRS bundling is enabled for uplink channel transmission, the UE may determine that the base station 1620 applies DMRS bundling based on the DMRS bundling enable. As a specific example, DMRS bundling may be enabled to improve PUSCH decoding performance, but is not limited to the embodiment. Also, as an example, the UE may transmit information on a time point at which the pre-compensation update is applied to the NTN base station 1620 in consideration of applying DMRS bundling. As a specific example, the UE may transmit update time point information for at least one of a common TA and a UE-specific TA to the NTN base station 1620 as pre-compensation update application time point information. As another example, the UE may report at least one of an update time point according to a validity duration and information on an epoch time reception/update application time point to the NTN base station 1620 as additional information on the pre-compensation update, but is not limited to the embodiment. The NTN base station 1620 may determine information on the ATDW/NTDW time interval based on the information reported from the UE 1610. That is, the NTN base station 1620 may determine whether to apply DMRS bundling for the received PUSCH. For example, when the above-described pre-compensation update procedure is performed within at least one ATDW/NTDW, the NTN base station 1620 may not perform DMRS bundling because it is difficult to maintain phase continuity and power consistency. On the other hand, when the above-described pre-compensation update procedure is not performed within at least one ATDW/NTDW, the NTN base station 1620 may perform DMRS bundling.

As another example, the NTN base station 1620 may not need the above-described information on the pre-compensation update procedure. As a specific example, in the case of an update according to a validity duration or epoch time reception/update, the NTN base station 1620 may directly derive the update timing information through a validity timer. Alternatively, the NTN base station 1620 may directly derive a timing at which the pre-compensation update is applied, without a report from the UE 1610, if it is predictable by the epoch time indication.

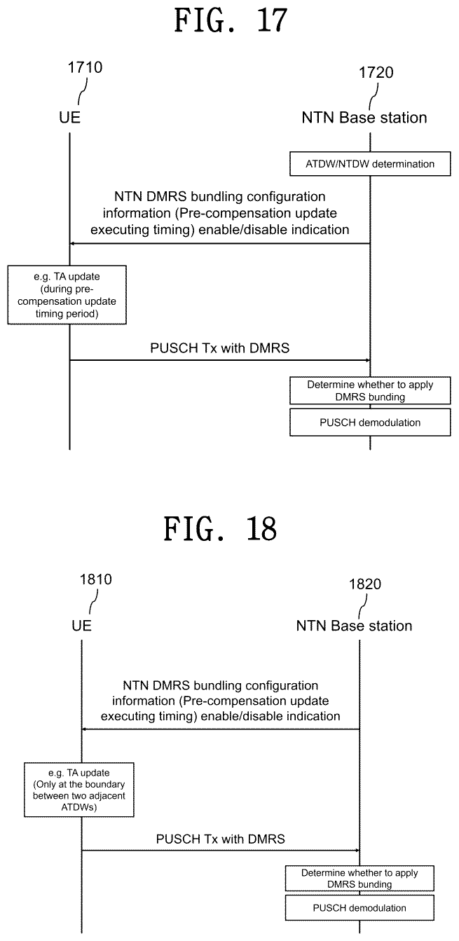

FIG. 17 is a diagram illustrating a method of applying PUSCH DMRS bundling based on pre-compensation update report applicable to the present disclosure. Referring to FIG. 17, the terminal 1710 may receive at least one of higher layer configuration information related to NTN DMRS bundling and DMRS bundling enable/disable indication information from the NTN base station 1720 in advance. For example, if the terminal receives an indication to enable DMRS bundling, it may apply DMRS bundling, and if it receives an indication to disable DMRS bundling, it may not apply DMRS bundling. If DMRS bundling is enabled for uplink channel transmission, the terminal may determine that the base station 1720 applies DMRS bundling based on the DMRS bundling enable. As a specific example, DMRS bundling may be enabled to improve PUSCH decoding performance, but is not limited to this embodiment. Here, for example, the higher layer configuration information related to NTN DMRS bundling may include configuration information for a pre-compensation update timing. That is, differently from FIG. 16, the terminal 1710 does not report information on the timing for applying the pre-compensation update to the NTN base station 1720, and the terminal 1710 may perform the pre-compensation update procedure only at the timing provided based on the higher layer signaling. For example, the NTN base station 1720 may not apply DMRS bundling for uplink channel demodulation (e.g., PUSCH) during the configured pre-compensation update timing. The NTN base station 1720 may apply DMRS bundling within the provided TDW after the configured timing.

FIG. 18 illustrates a method of applying PUSCH DMRS bundling in consideration of an ATDW boundary applicable to the present disclosure.

Referring to FIG. 18, the UE 1810 may perform the pre-compensation update procedure only at the boundary of two adjacent ATDW. Here, the NTN base station 1820 may not provide the UE 1810 with NTN specific/indication signaling as in FIG. 17.

As a specific example, the terminal 1810 may be provided in advance with at least one of upper layer configuration information related to NTN DMRS bundling and DMRS bundling enable/disable indication information from the NTN base station 1820. If DMRS bundling is enabled for uplink channel transmission, the terminal may determine that the base station 1820 applies DMRS bundling based on the DMRS bundling enable. As a specific example, DMRS bundling may be enabled to improve PUSCH decoding performance, but is not limited to the embodiment. Here, the upper layer configuration information related to NTN DMRS bundling may include TDW configuration information. The terminal 1810 may perform the above-described pre-compensation update procedure only at the boundaries of two adjacent ATDWs based on the TDW configuration information.

For example, the UE 1810 may perform the above-described pre-compensation update procedure only at the boundary of two adjacent ATDWs based on the configuration information for the ATDW without additional configuration or reporting. As another example, the UE 1810 may perform the above-described pre-compensation update procedure only at the boundary of two adjacent ATDWs based on the ATDW information derivable by the UE 1810 and the NTN base station 1820.

That is, the UE 1810 and the NTN base station 1820 may determine information on the same ATDW based on configuration information for the ATDW or ATDW information derivable by the UE 1810 and the base station 1820. Here, the UE 1810 may perform a pre-compensation update procedure on time corresponding to two adjacent ATDW boundaries based on the information. The NTN base station 1820 may not apply DMRS bundling on time corresponding to two adjacent ATDW boundaries based on the information. On the other hand, the NTN base station 1820 may apply DMRS bundling for PUSCH reception and decoding except for the time corresponding to the two adjacent ATDW boundaries.

As another example, when an event for a pre-compensation update procedure occurs, a time interval and a location corresponding to the actual ATDW/NTDW may be determined differently according to the occurrence of the event. Therefore, the UE and the NTN base station need to equally recognize when the above-described events occur in order to effectively apply DMRS bundling. For example, the NTN may set a validity timer to determine whether satellite ephemeris information is valid. The validity timer may mean a common TA related parameter and a maximum time for which satellite orbit force information is maintained. Therefore, the validity timer can determine the validity of the existing satellite orbit force information before new satellite orbit force information is provided. In addition, the validity timer is related to the common TA related parameter and the validity of the satellite orbit force information, and thus may affect whether phase continuity and power consistency are maintained. For example, when the validity timer expires (out-of-date), it may be difficult to apply DMRS bundling. In addition, the validity timer may be started (or restarted) with a valid period set in a specific epoch time. Therefore, the satellite orbit force and the common TA parameter can share the same epoch time. Here, when the epoch time is changed within one TDW, the validity timer needs to be restarted, and thus it may be difficult to maintain phase continuity and power consistency within the TDW. That is, there may be a limitation in applying DMRS bundling in the above-described situation. In consideration of the above, the epoch time indication and change may affect whether the validity timer starts. Here, the application timing of DMRS bundling may be different in consideration of the above-described validity timer, and is not limited to a specific embodiment.

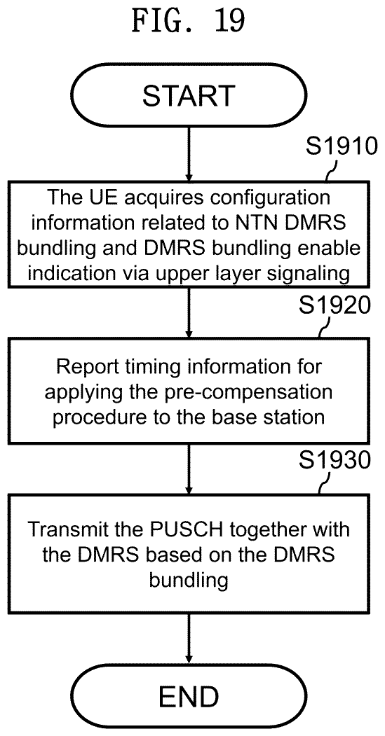

FIG. 19 is a flowchart illustrating a method of applying DMRS bundling in an NTN environment applicable to the present disclosure. Referring to FIG. 19, a wireless user device may obtain configuration information related to NTN DMRS bundling and DMRS bundling enable indication information through higher-layer signaling (S1910). Thereafter, the wireless user device transmits, to the base station, information on a timing for applying a pre-compensation procedure (S1920), and may transmit the PUSCH to the base station together with the DMRS through DMRS bundling based on the information on the timing for applying the pre-compensation procedure (S1930). Here, the pre-compensation procedure may include at least one of TA update, validity duration update, and epoch time reception/update, as described above. The base station considers maintaining uniform phase continuity and power consistency based on the information on the timing for applying the pre-compensation procedure received from the wireless user device, determines a nominal time domain window (NTDW) and an actual time domain window (ATDW), and may decode the PUSCH based on the DMRS bundling within the determined ATDW, as described above. In addition, when DMRS bundling is applied, the wireless user device may transmit at least one of DMRS and coherent DMRS in a plurality of slots.

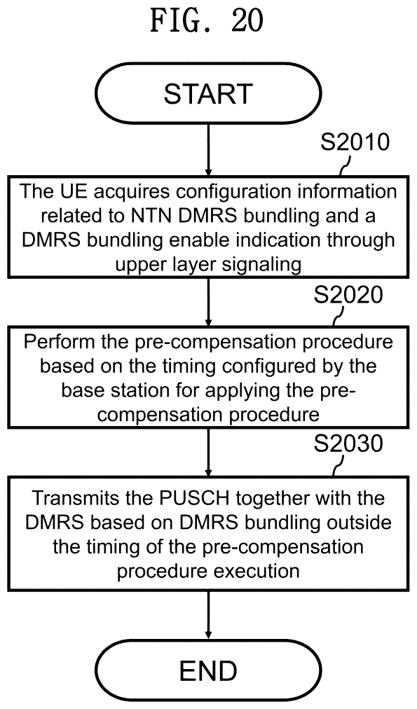

FIG. 20 is a sequence diagram illustrating a method of applying DMRS bundling in an NTN environment applicable to the present disclosure. Referring to FIG. 20, a wireless user device may obtain configuration information related to NTN DMRS bundling and DMRS bundling enable indication information through higher-layer signaling (S2010). Here, for example, a timing of applying a pre-compensation procedure may be included in the higher-layer signaling. The wireless user device performs the pre-compensation procedure based on the timing of applying the pre-compensation procedure configured by the base station (S2020), and may transmit the PUSCH together with the DMRS to the base station through DMRS bundling at a time other than the timing of performing the pre-compensation procedure. Here, for example, the pre-compensation procedure may include at least one of TA update, validity duration update, and epoch time reception/update. In addition, when DMRS bundling is applied, the wireless user device may transmit at least one of DMRS and coherent DMRS in a plurality of slots, as described above.

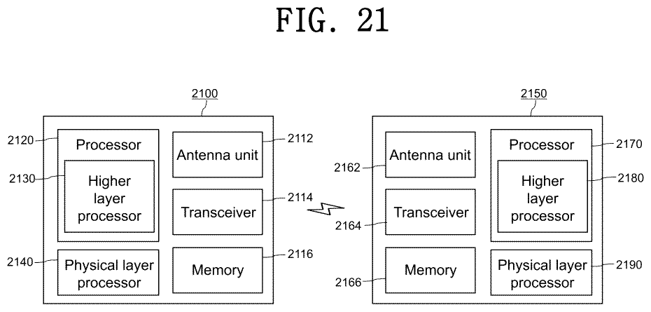

FIG. 21 is a diagram illustrating a device configuration to which the present disclosure may apply.

Referring to FIG. 21, a first device 2100 and a second device 2150 may perform communication with each other. Here, for example, the first device 2100 may be a base station device, and the second device 2150 may be a UE device. As another example, both the first device 2100 and the second device 2150 may be UE devices. That is, the first device 2100 and the second device 2150 may be devices that perform communication with each other based on NR-based communication.

For example, a case in which the first device 2100 is a base station device and the second device 2150 is a terminal device may be considered. In this case, the base station device 2100 may include a processor 2120, an antenna unit 2112, a transceiver 2114, and a memory 2116. The processor 2120 performs baseband-related signal processing and may include a higher layer processor 2130 and a physical layer processor 2140. The higher layer processor 2130 may process the operation of a medium access control (MAC) layer, a radio resource control (RRC) layer, or a higher layer thereof. The physical layer processor 2140 may process the operation of the physical (PHY) layer (e.g., uplink receive signal processing, downlink transmission signal processing). The processor 2120 may also control the overall operation of the base station device 2100, in addition to performing the baseband-related signal processing. The antenna unit 2112 may include one or more physical antennas. If the antenna unit 2112 includes a plurality of antennas, multiple input multiple output (MIMO) transmission and reception may be supported. Also, beamforming may be supported. The memory 2116 may store operation-processed information of the processor 2120, software, an OS, an application, etc., associated with an operation of the base station device 2100, and may include a component such as a buffer. The processor 2120 of the base station device 2100 may be configured to implement the operation of the base station in the embodiments described in the present invention.

The terminal device 2150 may include a processor 2170, an antenna device 2162, a transceiver 2164, and a memory 2166. For example, the terminal device 2150 may communicate with the base station device 2100. As another example, the terminal device 2150 may perform sidelink communication with another terminal device. That is, the terminal device 2150 of the present invention refers to any device capable of communicating with at least one of the base station device 2100 and another terminal device and is not limited to communication with a specific device. The processor 2170 performs baseband-related signal processing and may include a higher layer processor 2180 and a physical layer processor 2190. The higher layer processor 2180 may process the operation of the MAC layer, the RRC layer, or the higher layer. The physical layer processor 2190 may process the operations of the PHY layer (e.g., downlink receive signal processing, uplink transmission signal processing, sidelink signal processing). Also, to perform baseband-related signal processing, the processor 2170 may also control the operation of the terminal device 2150 as a whole. The antenna device 2162 may include one or more physical antennas, and if it includes a plurality of antennas, it may support MIMO transmission and reception. It may also support beamforming. The memory 2166 may store the computation-processed information of the processor 2170, software related to the operation of the terminal device 2150, an operating system, applications, etc., and may include components such as a buffer. The terminal device 2150 according to an example of the present invention may be associated with a vehicle. For example, the terminal device 2150 may be integrated into the vehicle, located in the vehicle, or located on the vehicle. Also, the terminal device 2150 according to the present invention may be the vehicle itself. Also, the terminal device 2150 according to the present invention may be at least one of a wearable terminal, an AV/VR terminal, an IoT terminal, a robot terminal, and a public safety terminal. The terminal device 2150 to which the present invention is applicable may be any type of communication device that supports interactive services using sidelink for services such as Internet access, service execution, navigation, real-time information, autonomous driving, safety and hazard diagnosis. Also, it may include any type of communication device that is an AR/VR device or a sensor capable of sidelink operation and performs relay operation.

Here, the vehicle/terminal to which the present disclosure applies may include an autonomous vehicle/terminal, a semi-autonomous vehicle/terminal, and a non-autonomous vehicle/terminal. Meanwhile, although the terminal device 2150 according to an example of the present disclosure is described in association with the vehicle, at least one of the UEs may not be associated with the vehicle. It is provided as an example only and should not be interpreted to limit application of the present disclosure. Also, the terminal device 2150 according to an example of the present disclosure may include various types of communication devices capable of performing cooperation that supports an interactive service using sidelink. That is, the terminal device 2150 may directly support the interactive service using the sidelink and may be employed as a cooperation device for supporting the interactive service using the sidelink.

The terminal device 2150 may acquire configuration information related to NTN DMRS bundling and DMRS bundling enable indication information through higher-layer signaling. Then, the terminal device 2150 transmits, to the base station, pre-compensation procedure application timing information based on the higher-layer signaling, and may transmit the PUSCH together with the DMRS to the base station device 2100 through DMRS bundling based on the pre-compensation procedure application timing information. Here, the pre-compensation procedure may include at least one of TA update, validity duration update, and epoch time reception/update, as described above. The base station device 2100 considers maintaining uniform phase continuity and power consistency based on the pre-compensation procedure application timing information received from the terminal device 2150, and determines a nominal time domain window (NTDW) and an actual time domain window (ATDW), and may decode the PUSCH based on DMRS bundling within the determined ATDW, as described above. Also, when DMRS bundling is applied, the terminal device 2150 may transmit at least one of DMRS and coherent DMRS in a plurality of slots.

As another example, the terminal device 2150 may obtain configuration information related to NTN DMRS bundling and DMRS bundling enable indication information through upper layer signaling. Here, for example, a timing for applying the pre-compensation procedure may be included in the upper layer signaling. The terminal device 2150 performs the pre-compensation procedure based on the timing for applying the pre-compensation procedure configured by the base station device 2100, and transmits the PUSCH together with the DMRS through DMRS bundling at a time other than the timing for performing the pre-compensation procedure to the base station device 2100. Here, for example, the pre-compensation procedure may include at least one of TA update, validity duration update, and epoch time reception/update. Also, when DMRS bundling is applied, the terminal device 2150 may transmit at least one of DMRS and coherent DMRS in a plurality of slots, as described above.

Also, various examples of the present disclosure may be implemented by hardware, firmware, software, or combination thereof. In the case of implementation by hardware, the examples may be implemented by one or more application-specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, etc.

The scope of the present disclosure includes software or machine-executable instructions (e.g., operating system, application, firmware, program, etc.) such that the operations of the methods of the various embodiments may be executed on a device or a computer, and a non-transitory computer-readable medium storing such software or instructions to be executable on a device or a computer.

The various embodiments of the present disclosure do not list all possible combinations and are for explaining representative aspects of the present disclosure, and matters described in the various embodiments may be applied independently or in a combination of two or more.

### INDUSTRIAL APPLICABILITY

The above matters can be applied to other systems.

1. A wireless user equipment (UE) connected to a satellite based on non-terrestrial networks (NTN) in a wireless communication system comprises,
at least one antenna for transmitting and receiving one or more wireless signals;
at least one processor; and
a memory that stores instructions for the wireless user equipment when executed by the at least one processor,
wherein the operation of the wireless user equipment includes:
acquiring configuration information related to NTN DMRS (demodulation reference signal) bundling and DMRS bundling enable indication information through higher layer signaling,
transmitting, based on the higher layer signaling, a timing of applying a pre-compensation procedure to the base station; and
transmitting a physical uplink shared channel (PUSCH) with a DMRS to the base station through DMRS bundling based on the information on the application time of the pre-compensation procedure.

2. The wireless UE of claim 1, wherein the pre-compensation procedure includes at least one of a TA update, a validity duration update, and an epoch time reception/update.

3. The wireless UE of claim 2,
wherein the base station determines a nominal time domain window (NTDW) and an actual time domain window (ATDW) based on the pre-compensation procedure application time information received from the wireless user equipment,
and decodes the PUSCH based on the DMRS bundling within the determined ATDW.

4. The wireless UE of claim 2,
wherein the wireless user equipment, when the DMRS bundling is applied, transmits at least one of a DMRS and a coherent DMRS in a plurality of slots.

5. A wireless user equipment (UE) that performs a conditional handover based on non-terrestrial networks (NTN) in a wireless communication system comprises:
at least one antenna for transmitting and receiving one or more wireless signals;
at least one processor; and
a memory that stores instructions for the wireless user equipment when executed by the at least one processor,
wherein the operation of the wireless user equipment comprises:
acquiring configuration information related to NTN DMRS (demodulation reference signal) bundling and DMRS bundling enable indication information through higher layer signaling,
performing a pre-compensation procedure based on a time point at which a pre-compensation procedure configured by the base station is applied, and
transmitting a physical uplink shared channel (PUSCH) with a DMRS to the base station through DMRS bundling, at a time other than the time of performing the pre-compensation procedure.

6. The wireless UE of claim 5,
wherein the application time point of the pre-compensation procedure is included in the higher layer signaling.

7. The wireless UE of claim 5,
wherein the pre-compensation procedure includes at least one of a TA update, a validity duration update, and an epoch time reception/update.

8. The wireless UE of claim 6,
wherein the wireless user equipment, when the DMRS bundling is applied, transmits at least one of a DMRS and a coherent DMRS in a plurality of slots.
